(19) United States
(12) Patent Application Publication
(10) Pub. No.: US 2026/0104942 A1
(43) Pub. Date: Apr. 16, 2026

(54) MEMORY TRAFFIC MANAGEMENT ACROSS A NETWORK OF PROCESSING ENGINES

(71) Applicant: Meta Platforms Technologies, LLC, Menlo Park, CA (US)

(72) Inventors: Pankaj Kansal, Fremont, CA (US); Olivia Wu, Los Altos, CA (US); Feng Wei, San Jose, CA (US); Nagesh Sreedhara, Saratoga, CA (US); Linda Cheng, San Jose, CA (US); Adam Hutchin, Mountain View, CA (US); Mahesh Srinivasa Maddury, San Jose, CA (US); Soheil Gharahi, Austin, TX (US)

(73) Assignee: Meta Platforms Technologies, LLC, Menlo Park, CA (US)

(21) Appl. No.: 19/357,619

(22) Filed: Oct. 14, 2025

Related U.S. Application Data
(60) Provisional application No. 63/707,625, filed on Oct. 15, 2024.

(51) Int. Cl. G06F 9/50

(52) U.S. Cl. CPC G06F 9/505; G06F 9/5044

(57) ABSTRACT

Embodiments include systems, methods, and computer-readable media for memory traffic management across a network of processing engines. An example method includes setting, at a processing engine prior to execution of a processing workload, a credit variable to an initial credit value, adding, at the processing engine during the execution of the processing workload, at a credit incrementing rate, a credit increment value to the credit variable, wherein the adding is omitted if the adding increases a current value of the credit variable above a maximum credit value, detecting, at the processing engine, a memory access request; blocking, at the processing engine, while the current value of the credit variable is less than a size of the memory access request, the memory access request, and issuing, from the processing engine, when the current value of the credit variable is equal to or greater than a size of the memory access request, the memory access request.

### CROSS-REFERENCE TO RELATED APPLICATION

This application claims the benefit of U.S. Application No. 63/707,625, filed Oct. 15, 2024, the entirety of which is hereby incorporated by reference.

### TECHNICAL FIELD

The present disclosure generally relates to computer memory traffic management, and more particularly to memory traffic management across a network of processing engines.

### BACKGROUND

In some computing architectures (e.g., inference application specific integrated circuits (ASICs), which are used to accelerate inferencing, or training, of machine learning models), compute workloads are executed by an array of compute engines called processing engines (PE). PEs can operate in a group or individually to perform a compute task. In one architecture, the PEs are laid out in a square or rectangular mesh connected to the memory subsystem on all four sides of the mesh via a Network-on-Chip (NoC) interconnect providing improved performance, reduced latency, and reliable channels for sharing data among PEs and memory subsystems. The grid NoC is built of routers and interconnects. Routers route transactions (i.e., memory requests and data) from one node to another along a route between a PE and a portion of memory. Each router is built with a limited number of buffers for transactions traversing through the router.

Memory organization is sprayed among caches and memory on all four sides of the grid to minimize hot spots in memory access. So, for a large size of sequential access, every consecutive request is likely to land in a different cache slice and memory. Thus, transactions from multiple PEs will be routed to all four directions via NoC routers. From the 2D grid perspective, a distance between PE and target memory will vary causing variable access latency for every 256-byte transaction. The variable latency causes proximity fairness issues in the NoC, as a PE placed close to a memory can fill the memory access pipeline to that memory, before a PE placed further from the same memory can issue its own memory requests. As a result, the close PD experiences lower latency than the further PE. For example, PEs at the north edge have faster access to memory placed in the north side compared to PEs placed at the south edge of the grid. Over the whole period of workload execution, there will be large variation of workload completion time among PEs, as some PEs will finish the work long before others, reducing the overall performance density of the compute cluster. This behavior also causes congestion in the NoC when multiple PEs issue memory access requests concurrently in executing the workloads. Further, because a memory request can involve multiple clock cycles worth of data, if multiple PEs issue memory requests at the same time, the first PE's request will take multiple clock cycles to complete before the request from one of the other PEs can start being sent over the same router.

Thus, to mitigate workload execution time variation and improve fairness among PEs, there is a need for memory traffic management at the PEs.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement memory traffic management across a network of processing engines, according to some embodiments.

FIG. 2 is a block diagram illustrating details of a system for memory traffic management across a network of processing engines, according to some embodiments.

FIG. 3 depicts a block diagram of an example configuration for memory traffic management across a network of processing engines, in accordance with an illustrative embodiment.

FIG. 4 depicts an example of a network of processing engines in which memory traffic management across a network of processing engines can be implemented, in accordance with an illustrative embodiment.

FIG. 5 depicts a flowchart of an example process for memory traffic management across a network of processing engines, in accordance with an illustrative embodiment.

FIG. 6 depicts another flowchart of an example process for memory traffic management across a network of processing engines, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing memory traffic management across a network of processing engines. In particular, an embodiment sets, at a processing engine prior to execution of a processing workload, a credit variable to an initial credit value; adds, at the processing engine during the execution of the processing workload, at a credit incrementing rate, a credit increment value to the credit variable, wherein the adding is omitted if the adding increases a current value of the credit variable above a maximum credit value; detects, at the processing engine, a memory access request; blocks, at the processing engine, while the current value of the credit variable is less than a size of the memory access request, the memory access request; and issues, from the processing engine, when the current value of the credit variable is equal to or greater than a size of the memory access request, the memory access request.

An embodiment configures processing engines in a network of processing engines to perform memory traffic management, based on the architecture of the network of processing engines. One embodiment sets a credit incrementing rate and a credit increment value based on the maximum bandwidth that can be supported between a PE and the NoC routers. For example, if a PE can support a bandwidth of 64 bytes per clock cycle and the NoC allows up to 256 bytes of requests to be pending, then a PE can be configured to issue 256 bytes of requests every four cycles, meaning 3 idle cycles between every two 256 byte requests to a NoC router from a PE. To configure a PE to issue 256 bytes of requests every four cycles, an embodiment might set a credit incrementing rate to one and a credit increment value to 64. An embodiment also sets a maximum credit value and an initial credit value to predefined values selected based on the architecture of the network of processing engines and the nature of the workloads on the network. The maximum credit value limits the total number of credits that can accumulate over the period of time when a PE is idle, to control burstiness during the initial period of workload execution. If there are a lot of credits available at the beginning of the execution, then PEs will issue multiple requests back-to-back until credits are exhausted completely. The initial credit value optimizes the number of idle cycles at the beginning of execution as PEs might take some time to accumulate enough credit before issuing a memory request to an NoC router.

At a processing engine prior to execution of a processing workload, an embodiment sets a credit variable to an initial credit value. The credit variable stores the number of credits a processing engine currently has available for use in issuing memory requests. Then, during execution of the processing workload, an embodiment adds, at a credit incrementing rate, a credit increment value to the credit variable. For example, if the credit incrementing rate is set to one and the credit increment value to 64, at every clock cycle an embodiment adds 64 credits to the credit variable. If the credit incrementing rate is set to four and the credit increment value to 256, at every fourth clock cycle an embodiment adds 256 credits to the credit variable. The addition is omitted if it would increase a current value of the credit variable above the maximum credit value.

During execution of the processing workload, asynchronously with the credit accumulation, an embodiment detects, at the processing engine, a memory access request (e.g., a request to read from memory or a cache, or data to write to memory or a cache). While the current value of the credit variable is less than a size of the memory access request, an embodiment blocks the memory access request from issuing from the processing engine. When the current value of the credit variable is equal to or greater than a size of the memory access request, an embodiment issues the memory access request. Issuing the memory access request includes subtracting the size of the memory access request from the current value of the credit variable.

For example, consider a scenario where the credit variable is initially set to 512 bytes, the credit incrementing rate is set to one, and the credit increment value is set to 64. An embodiment at a PE detects two 256-byte memory access requests from the PE. An embodiment issues both requests and subtracts 512 from the current value of the credit variable. Now the current value of the credit variable is zero. In the next four clock cycles, the current value of the credit variable is incremented by 64 each time. If an embodiment detects another 256-byte memory access request during this time, the current value of the credit variable is insufficient, and the memory access request is blocked until the current value of the credit variable is at least 256. Then an embodiment issues the previously blocked memory access request.

Another embodiment blocks issuance of a memory access request if there are too many memory access requests already outstanding. In particular, an embodiment increments an outstanding request count by one when a memory access request is issued to a router and decrements the outstanding request count by one when a response to a request is received from the router. However, if the outstanding request count is greater than a threshold value, an embodiment blocks issuance of a memory access request until the outstanding request count is less than or equal to the threshold value (because one or more already outstanding requests have been responded to). In embodiments, the threshold value is set based on the architecture of the network of processing engines (e.g., based on the maximum bandwidth that can be supported between a PE and the NoC routers) and the nature of the workloads on the network.

Another embodiment blocks issuance of a memory access request while the current value of the credit variable is less than a size of the memory access request or while there are too many memory access requests already outstanding, and issues a memory access request when the current value of the credit variable is equal to or greater than a size of the memory access request and the outstanding request count is less than or equal to the threshold value.

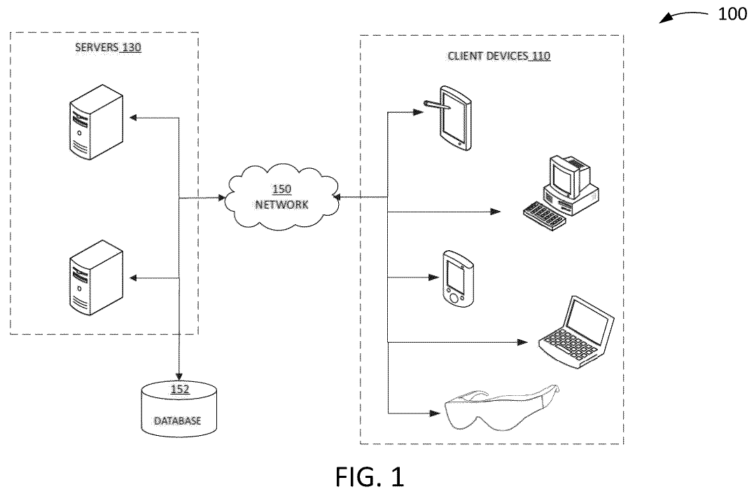

FIG. 1 illustrates a network architecture 100 used to implement memory traffic management across a network of processing engines, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

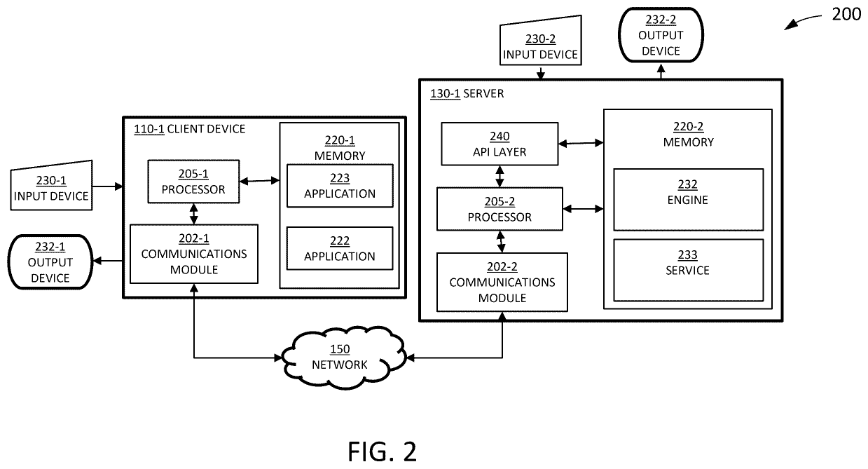

FIG. 2 is a block diagram illustrating details of a system 200 for memory traffic management across a network of processing engines, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement memory traffic management across a network of processing engines. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide memory traffic management across a network of processing engines. The application 223 may communicate with service 233 through API layer 240, for example.

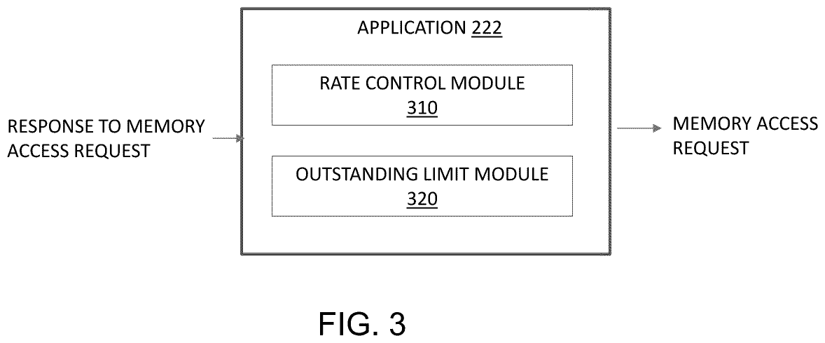

FIG. 3 depicts memory traffic management across a network of processing engines, in accordance with an illustrative embodiment. Application 222 is the same as application 222 in FIG. 2.

Rate control module 310, executing at a processing engine, configures the processing engine to perform memory traffic management, based on the architecture of the network of processing engines. One implementation of module 310 sets a credit incrementing rate and a credit increment value based on the maximum bandwidth that can be supported between a PE and the NoC routers. For example, if a PE can support a bandwidth of 64 bytes per clock cycle and the NoC allows up to 256 bytes of requests to be pending, then a PE can be configured to issue 256 bytes of requests every four cycles, meaning 3 idle cycles between every two 256-byte requests to an NoC router from a PE. To configure a PE to issue 256 bytes of requests every four cycles, module 310 might set a credit incrementing rate to one and a credit increment value to 64. Module 310 also sets a maximum credit value and an initial credit value to predefined values selected based on the architecture of the network of processing engines and the nature of the workloads on the network. The maximum credit value limits the total number of credits that can accumulate over the period of time when a PE is idle, to control burstiness during the initial period of workload execution. If there are a lot of credits available at the beginning of the execution, then PEs will issue multiple requests back-to-back until credits are completely exhausted. The initial credit value optimizes the number of idle cycles at the beginning of execution as PEs might take some time to accumulate enough credit before issuing a memory request to an NoC router.

Prior to execution of a processing workload, module 310 sets a credit variable to an initial credit value. The credit variable stores the number of credits a processing engine currently has available for use in issuing memory requests. Then, during execution of the processing workload, module 310 adds, at a credit incrementing rate, a credit increment value to the credit variable. For example, if the credit incrementing rate is set to one and the credit increment value to 64, at every clock cycle module 310 adds 64 credits to the credit variable. If the credit incrementing rate is set to four and the credit increment value to 256, at every fourth clock cycle module 310 adds 256 credits to the credit variable. The addition is omitted if it would increase a current value of the credit variable above the maximum credit value.

During execution of the processing workload, asynchronously with the credit accumulation, module 310 detects, at the processing engine, a memory access request. While the current value of the credit variable is less than a size of the memory access request, module 310 blocks the memory access request from issuing from the processing engine. When the current value of the credit variable is equal to or greater than a size of the memory access request, module 310 issues the memory access request. Issuing the memory access request includes subtracting the size of the memory access request from the current value of the credit variable.

For example, consider a scenario where the credit variable is initially set to 512 bytes, the credit incrementing rate is set to one, and the credit increment value is set to 64. Module 310 detects two 256-byte memory access requests from the PE. Module 310 issues both requests and subtracts 512 from the current value of the credit variable. Now the current value of the credit variable is zero. In the next four clock cycles, the current value of the credit variable is incremented by 64 each time. If module 310 detects another 256-byte memory access request during this time, the current value of the credit variable is insufficient, and the memory access request is blocked until the current value of the credit variable is at least 256. Then module 310 issues the previously blocked memory access request.

Outstanding limit module 320 blocks issuance of a memory access request if there are too many memory access requests already outstanding. In particular, module 320 increments an outstanding request count by one when a memory access request is issued to a router and decrements the outstanding request count by one when a response to a request is received from the router. However, if the outstanding request count is greater than a threshold value, module 320 blocks issuance of a memory access request until the outstanding request count is less than or equal to the threshold value (because one or more already outstanding requests have been responded to). In implementations of module 320, the threshold value is set based on the architecture of the network of processing engines (e.g., based on the maximum bandwidth that can be supported between a PE and the NoC routers) and the nature of the workloads on the network.

Another implementation of application 222 blocks issuance of a memory access request while the current value of the credit variable is less than a size of the memory access request or while there are too many memory access requests already outstanding, and issues a memory access request when the current value of the credit variable is equal to or greater than a size of the memory access request and the outstanding request count is less than or equal to the threshold value.

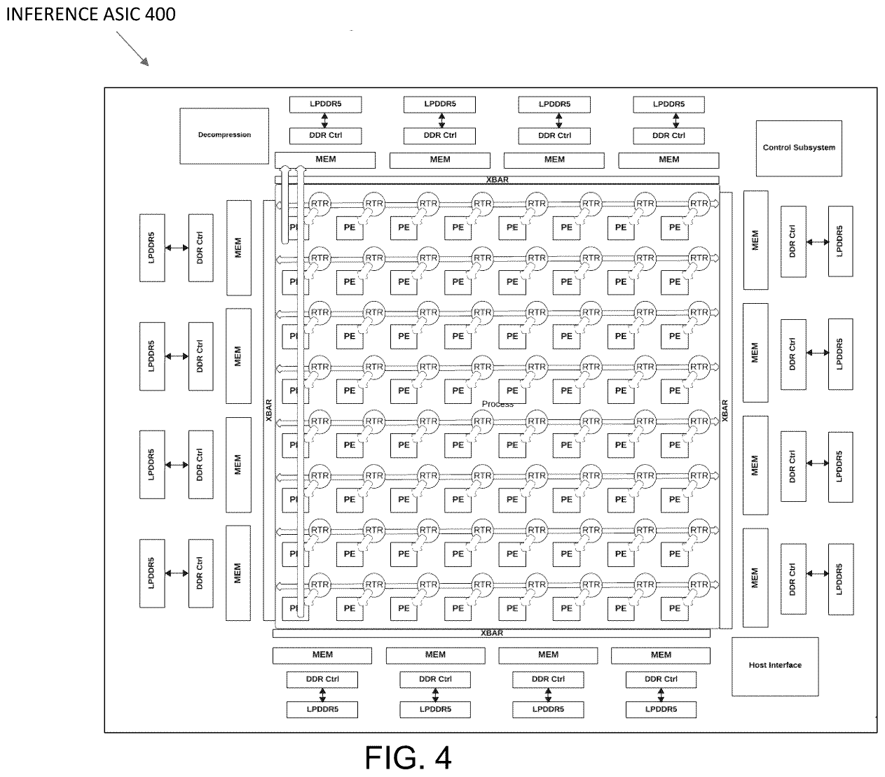

FIG. 4 depicts an example of a network of processing engines in which memory traffic management across a network of processing engines can be implemented, in accordance with an illustrative embodiment. The example can be executed using application 222 in FIG. 2.

In the example, PE denotes a processing engine in the network of processing engines, RTR denotes a router, and MEM denotes a memory. As depicted, if the top left PE and the bottom left PE both issue memory access requests at the same time to the same memory, the request from the top left PE has less distance, and fewer routers to pass through, than the bottom left PE, resulting in decreased latency for the top left PE compared to that for the bottom left PE.

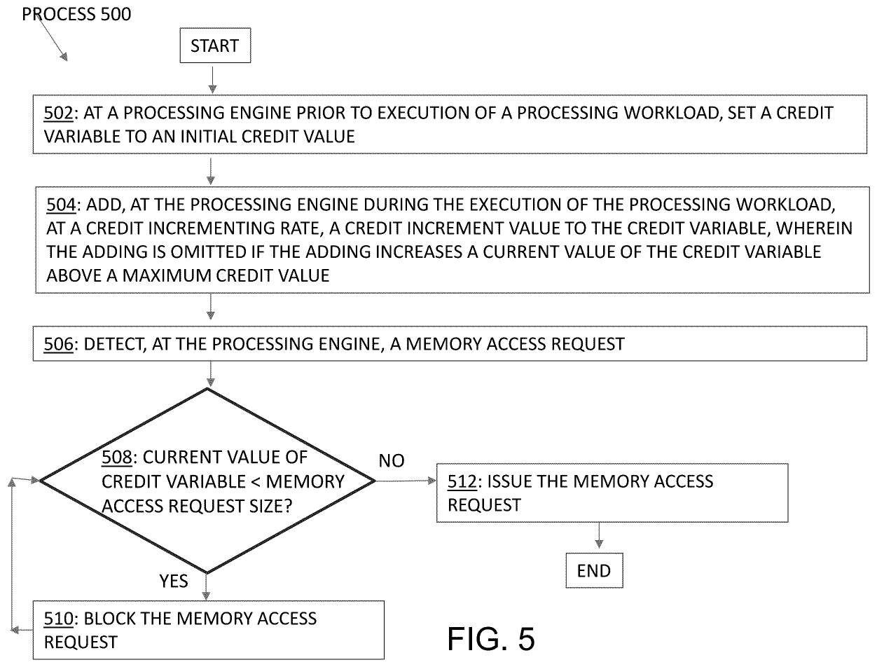

FIG. 5 depicts a flowchart of an example process for memory traffic management across a network of processing engines, in accordance with an illustrative embodiment. Process 500 can be implemented in application 222 in FIG. 2.

At block 502, the process, at a processing engine prior to execution of a processing workload, sets a credit variable to an initial credit value. At block 504, the process adds, at the processing engine during the execution of the processing workload, at a credit incrementing rate, a credit increment value to the credit variable, wherein the adding is omitted if the adding increases a current value of the credit variable above a maximum credit value. At block 506, the process detects, at the processing engine, a memory access request. At block 508, the process determines whether the current value of credit variable is less than the memory access request size. If yes (“YES” path of block 508), at block 510, the process blocks the memory access request, and returns to block 508. Otherwise (“NO” path of block 508), at block 512, the process issues the memory access request. Then the process ends.

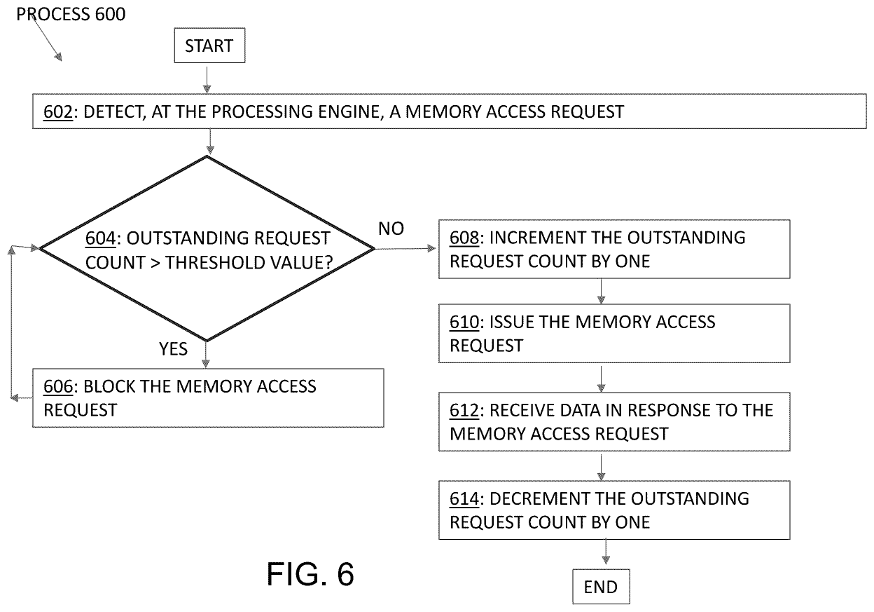

FIG. 6 depicts another flowchart of an example process for memory traffic management across a network of processing engines, in accordance with an illustrative embodiment. Process 600 can be implemented in application 222 in FIG. 2.

At block 602, the process detects, at the processing engine, a memory access request. At block 604, the process determines whether the outstanding request count is greater than a threshold value. If yes (“YES” path of block 604), at block 606, the process blocks the memory access request, and returns to block 604. Otherwise (“NO” path of block 604), at block 608, the process increments the outstanding request count by one. At block 610, the process issues the memory access request. At block 612, the process receives data in response to the memory access request. At block 614, the process decrements the outstanding request count by one. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
setting, at a processing engine prior to execution of a processing workload, a credit variable to an initial credit value;
adding, at the processing engine during the execution of the processing workload, at a credit incrementing rate, a credit increment value to the credit variable, wherein the adding is omitted if the adding increases a current value of the credit variable above a maximum credit value;
detecting, at the processing engine, a memory access request; blocking, at the processing engine, while the current value of the credit variable is less than a size of the memory access request, the memory access request; and
issuing, from the processing engine, when the current value of the credit variable is equal to or greater than a size of the memory access request, the memory access request.

2. The computer-implemented method of claim 1, wherein issuing the memory access request comprises subtracting the size of the memory access request from the current value of the credit variable.

3. The computer-implemented method of claim 1, further comprising:
detecting, at the processing engine, a second memory access request;
blocking, at the processing engine, while an outstanding request count is greater than a threshold value, the memory access request; and
issuing, from the processing engine, when the outstanding request count is less than or equal to the threshold value, the memory access request.

4. The computer-implemented method of claim 3, wherein the issuing comprises incrementing the outstanding request count by one.

5. The computer-implemented method of claim 3, further comprising:
receiving data in response to the memory access request; and decrementing the outstanding request count by one.

6. A non-transitory computer-readable medium storing a program, which when executed by a computer, configures the computer to perform the method of claim 1.

7. A system comprising: a processor; and a non-transitory computer-readable medium storing a set of instructions, which when executed by the processor, configure the system to perform the method of claim 1.
